(19) United States
(12) Patent Application Publication
(10) Pub. No.: US 2015/0119008 A1
(43) Pub. Date: Apr. 30, 2015

(54) METHOD OF REPRODUCING CONTENTS AND ELECTRONIC DEVICE THEREOF

(71) Applicant: Samsung Electronics Co., Ltd., Gyeonggi-do (KR)

(72) Inventors: Han-Sik Kim, Seoul (KR); Jun-Tae Lee, Seoul (KR)

(73) Assignee: Samsung Electronics Co., Ltd., Gyeonggi-do (KR)

(21) Appl. No.: 14/528,669

(22) Filed: Oct. 30, 2014

(30) Foreign Application Priority Data
Oct. 30, 2013 (KR) 10-2013-0130413

(51) Int. Cl. H04L 29/08; H04W 4/02

(52) U.S. Cl. CPC H04L 67/10; H04W 4/02
USPC 455/414.2

(57) ABSTRACT

A device and method for reproducing contents in an electronic device connected through a network are provided. The electronic device includes a communication unit for connecting a network to a second electronic device, an information collection module, which collects information necessary for determining a location of the second electronic device, and at least one processor, which determines the location of the second electronic device, based on the information collected by the information collection module, defines contents to reproduce in the second electronic device, based on the location, and provides the contents to the second electronic device.

### PRIORITY

This application claims priority under 35 U.S.C. §119(a) to a Korean Patent Application filed in the Korean Intellectual Property Office on Oct. 30, 2013, and assigned Serial No. 10-2013-0130413, the entire disclosure of which is incorporated herein by reference.

### BACKGROUND OF THE INVENTION

1. Field of the Invention

The present invention relates generally to a method of reproducing contents and an electronic device that performs the method.

2. Description of the Related Art

Nowadays, electronic devices having a convergence function of complexly performing at least one function have gradually increased.

Moreover, as a type of electronic device, a mobile terminal that may be classified as a ‘smart phone’ is generally used. Particularly, such a mobile terminal has a display module of a large screen which uses a touch method and has a high-resolution camera module, in addition to a basic function of communicating with another party, and thus may be used to photograph a still picture and a moving picture. Further, the mobile terminal may reproduce multimedia contents, such as music and a moving picture, and perform web surfing by connecting to a network. As such, a mobile terminal generally has a high performance processor. The mobile terminal has advanced to more quickly perform various convergence functions and has developed to the point that a main function of communicating with another party is regarded as an additional function.

An electronic device may form a sharing group by forming a network with at least one peripheral electronic device for sharing digital contents, and reproduce contents with electronic devices included in the sharing group. The digital contents may include an application formed with a picture, music, video, an e-book, a web page, and a multi-screen.

However, the electronic device reproduces contents without considering a location of electronic devices included in the sharing group.

### SUMMARY

The present invention has been made to address at least the above-mentioned problems and/or disadvantages and to provide at least the advantages described below.

Accordingly, an aspect of the present invention is to provide a method of reproducing contents and an electronic device that performs the method.

In accordance with an aspect of the present invention, an electronic device is provided. The electronic device includes a communication unit for connecting a network to a second electronic device, an information collection module, which collects information necessary for determining a location of the second electronic device, and at least one processor, which determines the location of the second electronic device, based on the information collected by the information collection module, defines contents to reproduce in the second electronic device, based on the location, and provides the contents to the second electronic device.

In accordance with another aspect of the present invention, a method of reproducing contents of an electronic device is provided. The method includes forming a group with at least one second electronic device, using a network, determining a location of the at least one second electronic device, defining a main component and a sub-component of reproduction contents, based on the location of the at least one second electronic device, and transmitting the main component and the sub-component to the at least one second electronic device.

In accordance with another aspect of the present invention, a non-transitory computer readable recording medium on which an application or a program is recorded in an electronic device is provided. The program is for performing determining at least one of a direction and a distance of a second electronic device, and defining contents to share, based on the direction or the distance of the second electronic device.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating a network environment using an electronic device, according to an embodiment of the present invention;

FIG. 2 is a block diagram illustrating a configuration of a programming module of the electronic device, according to an embodiment of the present invention.

FIG. 3 is a flowchart illustrating a content reproduction method of an electronic device, according to an embodiment of the present invention;

FIG. 4 is a flowchart illustrating a method of an electronic device of determining a location of a peripheral electronic device, according to an embodiment of the present invention;

FIG. 5 is a flowchart illustrating a method of an electronic device of determining a location of a peripheral electronic device, according to another embodiment of the present invention;

FIG. 6 is a flowchart illustrating a method of providing contents in an electronic device to a peripheral electronic device, according to an embodiment of the present invention;

FIG. 7 is a flowchart illustrating a method of reproducing contents of an electronic device in a peripheral electronic device, according to an embodiment of the present invention;

FIGS. 8A-8C are diagrams illustrating methods of an electronic device for determining a location of a peripheral electronic device in a sharing group, according to embodiments of the 5 present invention;

FIGS. 9A-9B is a diagram illustrating a method of reproducing content in a peripheral electronic device, according to an embodiment of the present invention;

FIGS. 10A-10C are diagrams illustrating a method of an electronic device for determining a location of a peripheral electronic device in a sharing group, according to embodiments of the present invention; and

FIG. 11 is a block diagram illustrating a configuration of an electronic device, according to an embodiment of the present invention.

### DETAILED DESCRIPTION OF EMBODIMENTS OF THE PRESENT INVENTION

Hereinafter, embodiments of the present invention and the various features and advantageous details thereof will be described more fully with reference to the accompanying drawings. Detailed descriptions of well-known functions and structures incorporated herein may be omitted to avoid obscuring the subject matter of the present invention. The terms used herein are defined according to the functions of the present invention. Thus, the terms may vary depending on a user's or an operator's intention and usage. That is, the terms used herein should be understood based on the descriptions made herein. It should be apparent to those skilled in the art that the examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

In the following description, an electronic device may include at least one of a smart phone, a tablet Personal Computer (PC), a mobile phone, a video phone, an e-Book reader, a desktop PC, a laptop PC, a netbook computer, a Personal Digital Assistant (PDA), a Portable Multimedia Player (PMP), a Moving Picture Experts Group layer-3 (MP3) player, a mobile medical device, a camera, a wearable device, an electronic clock, a wrist watch, a refrigerator, an air-conditioner, a vacuum cleaner, an artificial intelligence robot, a television, a Digital Video Disk (DVD) player, an audio device, an oven, a microwave oven, a washing machine, an air cleaner, a medical device (e.g., a Magnetic Resonance Angiography (MRA) device, a Magnetic Resonance Imaging (MRI) device, a Computed Tomography (CT) device, a scanning machine, and an ultrasonic wave device), a navigation device, a Global Positioning System (GPS) receiver, an Event Data Recorder (EDR), a Flight Data recorder (FDR), a set-top box, a television box (e.g., Samsung HomeSync™), an electronic dictionary, a vehicle infotainment device, electronic equipment for a ship (e.g., a navigation device for a ship and a gyro compass), avionics, a security device, a camcorder, a game console, a portion of furniture or a building/structure including an electronic device, an electronic board, an electronic signature receiving device, and a projector.

An electronic device according to an embodiment of the present invention is not limited to the foregoing devices.

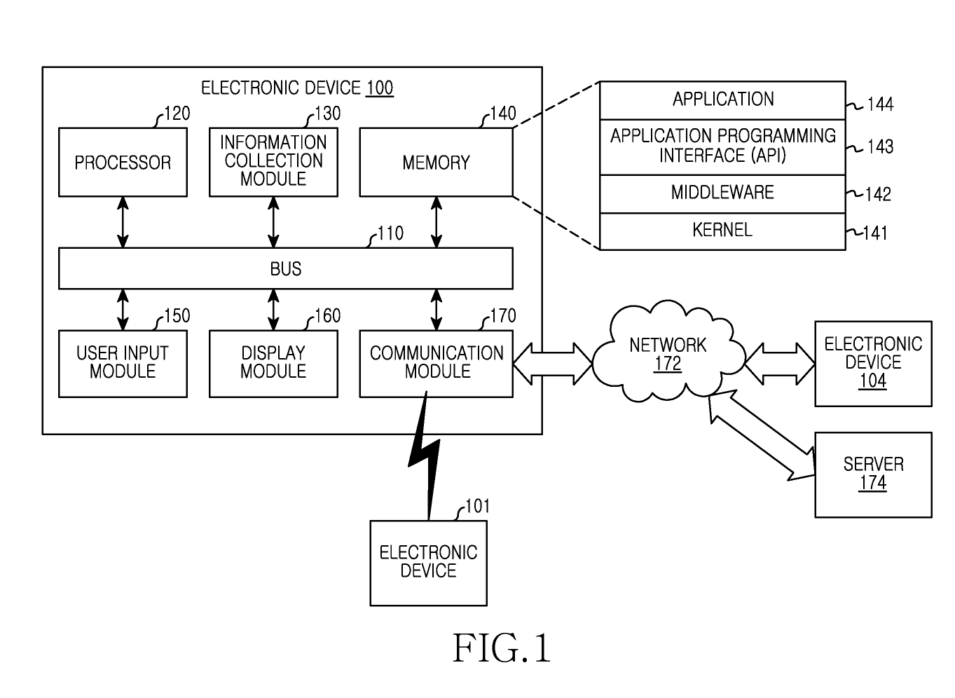

FIG. 1 is a block diagram illustrating a network environment using an electronic device, according to an embodiment of the present invention.

Referring to FIG. 1, an electronic device 100 includes a bus 110, a processor 120, an information collection module 130, a memory 140, a user input module 150, a display module 160, and a communication module 170.

The bus 110 is a circuit that connects the foregoing constituent elements and that transmits communication (e.g., a control message) between the foregoing constituent elements.

The processor 120 receives an instruction from the other elements of the electronic device 100 (e.g., the information collection module 130, the memory 140, the user input module 150, the display module 160, and the communication module 170) through, for example, the bus 110, decodes the received instruction, and executes operation or a data processing, according to the decoded instruction.

The processor 120 determines a location of peripheral electronic devices formed as a sharing group and controls to reproduce contents based on the determined location.

According to an embodiment of the present invention, the processor 120 determines a direction and a distance of a peripheral electronic device based on information collected through the information collection module 130. The processor 120 defines contents to provide to a peripheral electronic device within a sharing group based on a location of peripheral electronic devices. The processor 120 divides contents to be reproduced through the sharing group into a main component and a sub-component and defines a component of the contents to provide to each peripheral electronic device based on the location of the peripheral electronic devices.

The information collection module 130 collects information that is used for determining a location of at least one peripheral electronic device. According to an embodiment of the present invention, the information collection module 130 includes a sensor, and the sensor may include a plurality of sensors (e.g., a grip sensor, an optical sensor, and an approach sensor) that can detect approach of an image sensor, a microphone, or a peripheral electronic device.

The memory 140 stores an instruction or data received from at least one constituent element (the processor 120, the information collection module 130, the user input module 150, the display module 160, and the communication module 170) included in the electronic device 100 or generated by at least one constituent element. For example, the memory 140 may store information, such as a direction and a distance corresponding to information collected through the information collection module 130, and location information that can be determined based on the information in the electronic device 100.

The memory 140 may include programming modules such as a kernel 141, middleware 142, an Application Programming Interface (API) 143, and an application 144. In this case, each programming module may include at least one of software, firmware, and hardware.

The kernel 141 controls or manages at least one system resource used for executing an operation or a function implemented by another programming module (e.g., the middleware 142, the API 143, or the application 144) included in the memory 140. Further, the kernel 141 provides an interface that provides access to an individual constituent element of the electronic device 100, from at least one of the middleware 142, the API 143, and the application 144, to control or manage the individual constituent element. Here, the system resource may include at least one of the bus 110, the processor 120, and the memory 140.

The middleware 142 performs an intermediary function of transmitting and receiving data by enabling the API 143 or the application 144 to communicate with the kernel 141. Further, the middleware 142 performs uniform load balancing of work requests received from at least one application 144.

The middleware 142 provides a function through the API 143 so that the application 144 may efficiently use a limited system resource within the electronic device 100. Further, in order to provide a function which the application 144 commonly requires, the middleware 142 may include a previously implemented plurality of modules.

The API 143 includes an interface that enables the application 144 to control a function of providing in the kernel 141 or the middleware 142. For example, the API 143 include at least one interface or function such as a file control, a window control, an image processing, or a text control.

The user input module 150 receives, for example, an input of an instruction or data from a user to output the input to the processor 120, the information collection module 130, or the memory 140 through the bus 110. According to an embodiment of the present invention, the user input module 150 may include a touch panel, a keypad, and a pen sensor and generate an input of controlling content sharing operation.

The display module 160 displays a picture, an image, or data to a user.

The communication module 170 may connect communication between the electronic device 100 and another electronic device 101 or 104. Or the communication module 170 may connect communication between the server 174 and the electronic device 100. The communication module 170 may support a predetermined short range communication protocol (e.g., WiFi, Bluetooth (BT), Near Field Communication (NFC), or communication of a predetermined network 172 (e.g., Internet, a Local Area Network (LAN), a Wide Area Network (WAN), a telecommunication network, a cellular network, a satellite network, or Plain Old Telephone Service (POTS)). The peripheral electronic devices 101 and 104 each is the same type of device as the electronic device 100 or may be a different type of device from the electronic device 100. The communication module 170 transmits and receives a component of contents defined based on a location of a peripheral electronic device.

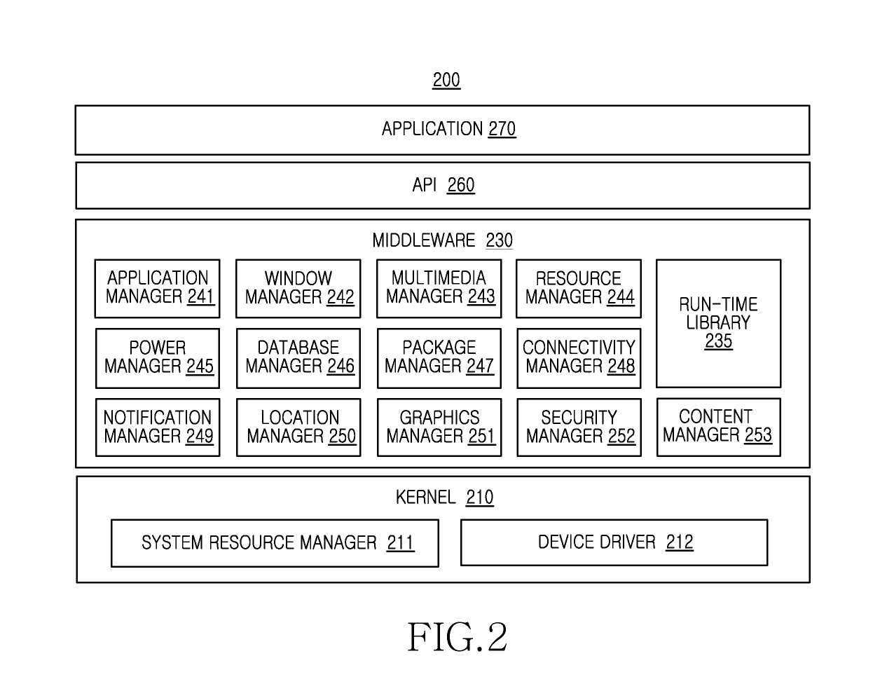

FIG. 2 is a block diagram illustrating a configuration of a programming module of the electronic device, according to an embodiment of the present invention.

Referring to FIG. 2, a programming module 200 includes a kernel 210, middleware 230, an API 260, or an application 270. Here, the programming module 200 is stored at the memory 140 of the electronic device 100, as shown in FIG. 1.

The programming module 200 includes an Operation System (OS) which controls a resource related to the electronic device 100 or the application 270 driven in the OS. For example, the OS may include at least one of Android, iOS, Windows, Symbian, Tizen, and Bada.

The kernel 210 includes at least one of a system resource manager 211 and a device driver 212.

The system resource manager 211 controls, allocates, or recovers a system resource. For example, the system resource manager 211 may include at least one of a process management unit, a memory management unit, and a file system management unit.

The device driver 212 controls a system resource used for executing an operation or a function implemented by another constituent element (e.g., the middleware 230, the API 260, or the application 270) of the programming module 200. For example, the device driver 212 may include at least one of a display driver, a camera driver, a Bluetooth driver, a sharing memory driver, a Universal Serial Bus (USB) driver, a keypad driver, a wireless LAN driver, a sensor driver, an audio driver, and an Inter-Process Communication (IPC) driver.

In order to provide a function which the application 270 commonly requires, the middleware 230 may include a previously implemented plurality of modules. Further, the middleware 230 provides a function through the API 260 so that the application 270 may efficiently use a limited system resource within the electronic device 100. For example, the middleware 230 includes at least one of a run-time library 235, an application manager 241, a window manager 242, a multimedia manager 243, a resource manager 244, a power manager 245, a database manager 246, a package manager 247, a connectivity manager 248, a notification manager 249, a location manager 250, a graphics manager 251, a security manager 252, and a content manager 253.

In order to add a new function through a programming language while the application 270 is being executed, the run-time library 235 may include a library module which a compiler uses. For example, the run-time library 235 may perform a function of an input and output, memory management, or an arithmetic function.

The application manager 241 manages a life cycle of the application 270.

The window manager 242 manages a Graphical User Interface (GUI) resource used on a screen of the electronic device 100.

The multimedia manager 243 determines a format necessary for reproduction of various media files. Further, the multimedia manager 243 may encode or decode a media file using a codec corresponding to a format necessary for reproduction of media files.

The resource manager 244 manages a resource of a source code, a memory, or a stored space of the application 270.

The power manager 245 manages a battery or power by operating together with a Basic Input/Output System (BIOS) and provides power information necessary for operation of the electronic device 100.

The database manager 246 manages to generate, search for, or change a database to use in the application 270.

The package manager 247 manages installation or update of an application distributed in a format of a package file.

The connectivity manager 248 manages wireless connection of the electronic device 100.

The notification manager 249 displays or notifies a user of the electronic device 100 of an event of a received message, an appointment, and a proximity notification with a method that does not disturb a user.

The location manager 250 manages location information of the electronic device 100.

The graphics manager 251 manages a graphics effect to be provided to a user or a user interface of the electronic device 100.

The security manager 252 provides several security functions necessary for system security or user authentication.

The content manager 253 provides a content reproduction function based on a location of a peripheral electronic device.

The content manager 253 defines contents to provide to a peripheral electronic device within a sharing group based on a location of peripheral electronic devices. According to an embodiment of the present invention, the content manager 253 divides contents, to be reproduced through a sharing group, into a main component and a sub-component and defines a component to provide to each peripheral electronic device based on the location of the peripheral electronic device. For example, the content manager 253 classifies a component of contents to reproduce and provides to a peripheral electronic device, a component classified based on a location of the peripheral electronic device. According to an embodiment of the present invention, the content manager 253 classifies a left channel (channel L) and a right channel (channel R) in audio data and defines a channel to provide to each peripheral electronic device.

According to another embodiment of the present invention, the content manager 253 divides image data into a plurality of areas and defined an area to provide to each peripheral electronic device.

According to another embodiment of the present invention, the content manager 253 divides an execution screen of an application into a main screen and a sub screen and defines a screen to provide to each peripheral electronic device. The content manager 253 provides a content component which is defined based on the location of each peripheral electronic device.

When the electronic device 100 provides an audio dedicated communication or audiovisual communication service, the middleware 230 may further include a telephony manager for managing the audio dedicated communication or audiovisual communication service of the electronic device 100.

The middleware 230 may generate and use a new middleware module through various function combinations of the internal constituent element modules. In order to provide a distinguished function, the middleware 230 may provide a specialized module on a kind basis of an operation system. Further, the middleware 230 may dynamically partially delete an existing constituent element or add new constituent elements. Therefore, some constituent elements described in an embodiment of the present invention may be omitted or other constituent elements is further included, or the constituent element is replaced with a constituent element that has another name and that performs a similar function.

The API 260 may be provided with another configuration according to an operation system with a set of API programming functions.

The application 270 includes at least one of a preloaded application and a third party application.

According to various embodiments of the present invention, an electronic device 100 includes: a communication module 170 for connecting a network to a peripheral electronic device; an information collection module 130 that collects information necessary for determining a location of the peripheral electronic device; and at least one processor 120, wherein the processor determines a location of the peripheral electronic device based on information collected by the information collection module, defines components of contents to reproduce in the peripheral electronic device based on the determined location, and provides the defined components to the peripheral electronic device.

According to various embodiments of the present invention, the information collection module 130 includes at least one of an image sensor, a microphone, a grip sensor, an optical sensor, and an approach sensor.

According to various embodiments of the present invention, the processor 120 determines location information corresponding to at least one of a direction and a distance of the peripheral electronic device.

According to various embodiments of the present invention, the contents include at least one of applications formed with a picture, music, video, an e-book, a web page, and a multi-screen.

According to various embodiments of the present invention, the processor 120 determines a sound source reproduced by the peripheral electronic device to determine a location of the peripheral electronic device.

According to various embodiments of the present invention, the processor 120 detects approach of the peripheral electronic device to determine a location of the peripheral electronic device.

According to various embodiments of the present invention, the processor 120 defines contents to provide to at least one peripheral electronic device connected to the electronic device 100.

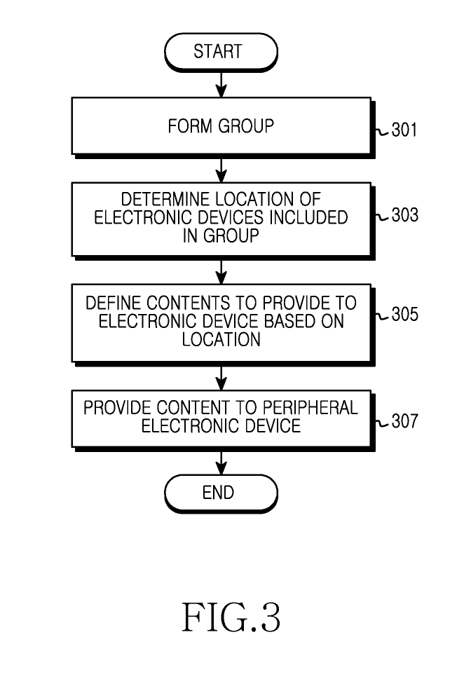

FIG. 3 is a flowchart illustrating a content reproduction method of an electronic device, according to various embodiments of the present invention.

Referring to FIG. 3, in step 301, the electronic device 100 forms a group for sharing contents. The electronic device forms a network with at least one peripheral electronic device, thereby allowing for the sharing of digital contents. In a state in which a sharing group is formed, the electronic device 100 serves as the master electronic device of the sharing group. The master electronic device, is the device which streams the digital contents. The remaining electronic devices belonging to the sharing group serve as the slave electronic devices. The digital contents may include various contents which is shared through a network, such as an application formed with a picture, music, video, an e-book, a web page, and a multi-screen.

In step 303, the electronic device 100 determines a location (e.g., direction, distance) of the electronic devices included in the group. In order to determine a location of peripheral electronic devices, the electronic device may include at least one sensor.

According to an embodiment of the present invention, the sensor may include a plurality of sensors (e.g., a grip sensor, an optical sensor, and an approach sensor) that can detect an approach of an image sensor, a microphone, or a peripheral electronic device.

In step 305, the electronic device 100 defines contents to provide to an electronic device within a sharing group based on a location of a peripheral electronic device. The electronic device 100 then divides the contents into components to be reproduced in the peripheral electronic devices in the sharing group, and provides the divided components to each peripheral electronic device.

According to an embodiment of the present invention, the contents may be stereo audio data. In this case, the electronic device 100 divides a channel L and a channel R of audio data and defines a channel to provide to each peripheral electronic device.

According to another embodiment of the present invention, the contents may be image data. In this case, the electronic device 100 divides the image data into a plurality of areas and defines an area to provide to each peripheral electronic device.

According to another embodiment of the present invention, the contents may be an application which supports a multi-screen. In this case, the electronic device 100 divides an execution screen of the application into a main screen and a sub screen, and defines a screen to provide to each peripheral electronic device.

In step 307, the electronic device 100 provides components of the defined content to each peripheral electronic device, thereby sharing and reproducing contents.

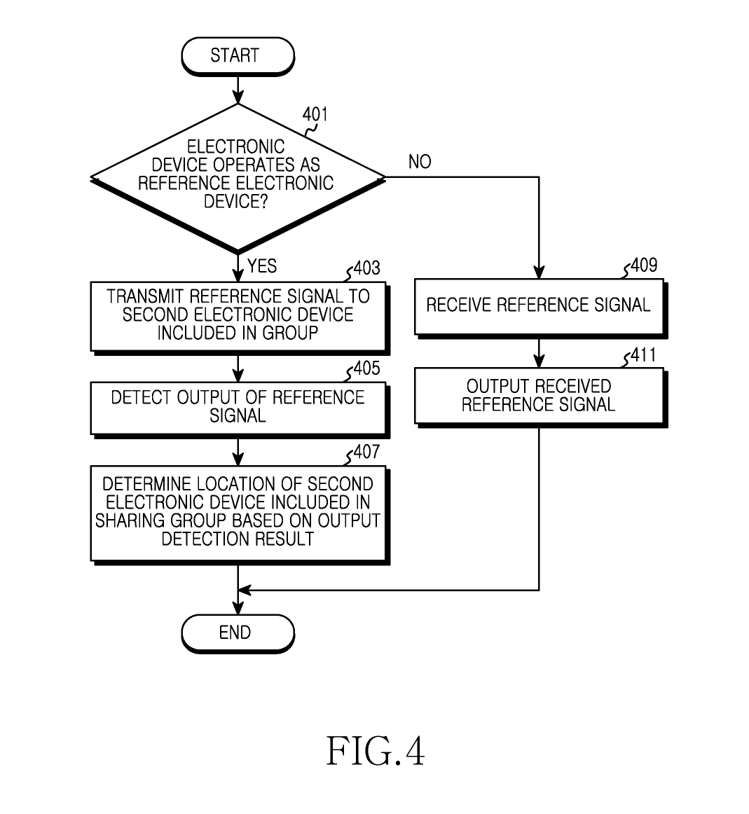

FIG. 4 is a flowchart illustrating a method of an electronic device of determining a location of a peripheral electronic device, according to an embodiment of the present invention.

Referring to FIG. 4, in step 401, the electronic device 100 determines whether the electronic device 100 operates as a reference electronic device. Here, the reference electronic device is an electronic device that provides contents to peripheral electronic devices included in a sharing group. The reference electronic device is a master electronic device that streams digital contents. In the following description, an electronic device operating as a reference electronic device is defined as a first electronic device, and a peripheral electronic device is defined as a second electronic device.

In step 403, if the electronic device 100 operates as a reference electronic device, the first electronic device transmits a reference signal to the second electronic device included in the sharing group. According to an embodiment of the present invention, the reference signal may be provided by the first electronic device as a test sound source to be reproduced in the second electronic device. According to another embodiment of the present invention, the reference signal may be random sound source data (e.g., a bell or a guidance sound that is generated by each second electronic device, or an audio data stored in memory) stored at the second electronic device.

In step 405, the first electronic device detects an output of a reference signal reproduced in a second electronic device included in the sharing group.

According to an embodiment of the present invention, the first electronic device may include at least one sensor. The sensor may include a microphone. According to an embodiment of the present invention, the first electronic device may detect a sound generated in a second electronic device with a microphone and thus determine a location of the second electronic device. According to an embodiment of the present invention, in the first electronic device, for example, at the circumferential edge of the first electronic device, a plurality of microphones may be disposed. According to another embodiment of the present invention, the microphone may include both a microphone which is able to detect a direction of a sound and a microphone which is not able to detect a direction of a sound.

According to an embodiment of the present invention, in the sharing group, a plurality of second electronic devices may be included, and a plurality of second electronic devices may generate a reference signal at a similar time point. By designating a random order of second electronic devices, the electronic device 100 enables a reference signal to be sequentially reproduced.

In step 407, the first electronic device determines a location of a second electronic device included in the sharing group based on an output detection result. According to an embodiment of the present invention, the first electronic device may determine a second electronic device located at the right side, the left side, the upper side, the lower side or in a diagonal direction based on a location thereof.

In step 401, if the electronic device 100 does not operate as a reference electronic device and instead operates as a second electronic device, then in step 409, the electronic device 100 may receive a reference signal.

In step 411, the electronic device 100 outputs the received reference signal. The second electronic device may receive a reference signal from the first electronic device or may receive an instruction that instructs to reproduce a reference signal. When the second electronic device receives an instruction that instructs to reproduce a reference signal, the second electronic device may use and reproduce an already stored random sound source as a reference signal.

FIG. 4 illustrates a method of the electronic device 100 determining a location of a second electronic device by detecting an output of a reference signal. However, according to various embodiments of the present invention, the electronic device 100 may determine a location of a second electronic device using intensity and direction of a receiving signal of a second electronic device, and intensity and direction of a vibration.

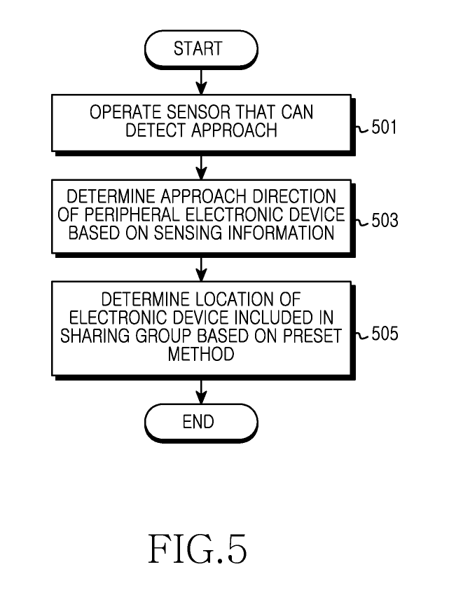

FIG. 5 is a flowchart illustrating a method of an electronic device of determining a location of a peripheral electronic device, according to another embodiment of the present invention;

Referring to FIG. 5, the electronic device 100 includes a sensor (e.g., a grip sensor, an optical sensor, and an approach sensor) that can detect an approach of a peripheral electronic device. According to an embodiment of the present invention, the sensor may be disposed at the circumferential edge of an electronic device corresponding to a predetermined direction.

In step 501, the electronic device operates a sensor that can detect an approach of a peripheral electronic device. The electronic device collects sensing information through an operating sensor.

In step 503, the electronic device determines an approach direction of a peripheral electronic device based on the sensing information.

In step 505, the electronic device 100 determines a location (e.g., a distance and a direction) of a peripheral electronic device included in a sharing group based on a preset method. According to an embodiment of the present invention, the preset method may be a previously defined direction on a sensor basis. According to another embodiment of the present invention, the electronic device may determine a direction corresponding to a sensor, having a detected approach as an approach direction of the peripheral electronic device.

According to an embodiment of the present invention, the senor may be disposed at the right side, the left side, the upper side, and the lower side of the circumferential edge of the electronic device 100. The sensor is a sensor that can recognize a dielectric material approaching into a predetermined range. As an area of the sensor increases, a range that can recognize a dielectric material is extended.

The electronic device 100 may previously set an operation mode, and when the electronic device 100 detects the approach of a peripheral electronic device, the electronic device 100 may perform the preset operation mode. The operation mode may include one of a master mode that provides contents and a slave mode that reproduces the provided contents.

FIGS. 4 and 5 illustrate method of various embodiments of the present invention, for determining a location of a peripheral electronic device. However, according to various embodiments of the present invention, the electronic device 100 may determine a location of a peripheral electronic device using an image sensor. The electronic device 100 may acquire an image with a subject of the peripheral electronic devices and analyze the acquired image, thereby determining a location of peripheral electronic devices.

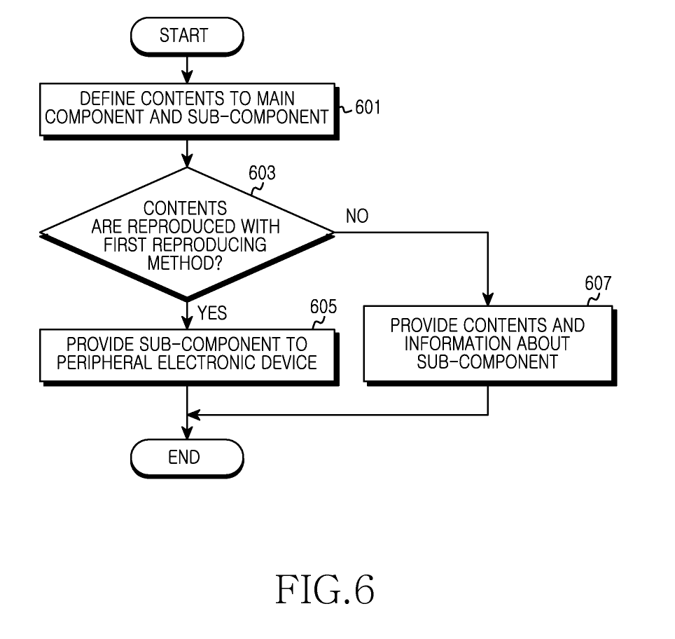

FIG. 6 is a flowchart illustrating a method of providing contents in an electronic device to a peripheral electronic device, according to various embodiments of the present invention;

Referring to FIG. 6, the electronic device 100 is a master electronic device (i.e., a first electronic device) that provides contents to peripheral electronic devices included in a sharing group.

In step 601, the electronic device 100 defines contents to provide to peripheral electronic devices included in a sharing group. The contents may be formed with a plurality of components. The components are divided into a main component and a sub-component. The main component is the component of content reproduced in the electronic device 100, and the sub-component is a component of content reproduced in the peripheral electronic device.

According to an embodiment of the present invention, the contents may be audio data, and the components constituting the audio data may be a channel L and a channel R of audio data. According to another embodiment of the present invention, the contents may be an image data, and the components constituting the image data may be a first area of image data and a second area of image data. According to another embodiment of the present invention, the contents may be an application which supports a multi-screen, and the components constituting the application may be a main screen and a sub screen of an application execution screen.

In step 603, the electronic device 100 determines whether contents are reproduced with a first reproducing method. The electronic device 100 supports a first reproducing method of extracting components of the contents to reproduce and providing the extracted components to each peripheral electronic device. The electronic device 100 may also support a second reproducing method of extracting a component from each peripheral electronic device.

In step 605, if contents are reproduced with a first reproducing method, the electronic device 100 extracts a sub-component from the contents and provides the extracted sub-component to a corresponding peripheral electronic device. According to an embodiment of the present invention, the electronic device 100 may extract a channel R and a channel L of audio data. The electronic device 100 may define at least one channel (e.g., channel L) as a sub-component and provide the sub-component to a peripheral electronic device.

If contents are not reproduced with a first reproducing method, at step 603, and are instead reproduced with a second reproducing method, then in step 607, the electronic device 100 provides contents and information about a sub-component to be reproduced in a peripheral electronic device to the corresponding peripheral electronic device. According to an embodiment of the present invention, by providing audio data and information that instructs electronic device 100 to use a channel L as a sub-component to be provided to a peripheral electronic device, the electronic device 100 enables the peripheral electronic device to extract and reproduce a channel L in received audio data.

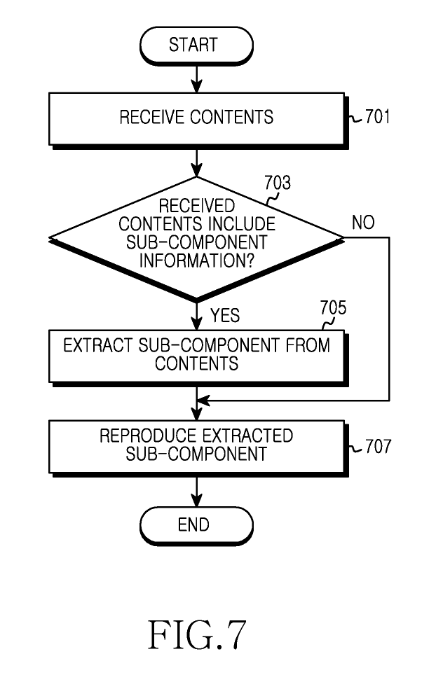

FIG. 7 is a flowchart illustrating a method of reproducing contents of an electronic device in a peripheral electronic device, according to various embodiments of the present invention;

Referring to FIG. 7, the electronic device 100 is an electronic device that receives and reproduces contents from at least one electronic device included in a sharing group.

In step 701, the electronic device 100 forms a sharing group and receives contents to reproduce. According to an embodiment of the present invention, the contents include various contents that may be shared through a network, such as an application formed with a picture, music, video, an e-book, a web page, and a multi-screen. According to an embodiment of the present invention, the electronic device 100 receives contents or at least one component of the contents.

In step 703, the electronic device 100 determines whether the received contents include only first sub-component information or whether the received contents include first sub-component information and second sub-component information. Here, the first sub-component information is information representing a component of contents to be reproduced by the electronic device 100 which receives the contents, and the second sub-component information is information representing a component of contents to be reproduced by a peripheral electronic device.

In step 705, if the received contents include the first sub-component information and the second sub-component information, the electronic device 100 extracts the first sub-component from the received contents.

In step 707, the electronic device reproduces only the extracted first sub-component among the components constituting the received contents.

In step 703, if the received contents include only the first sub-component information, then in step 709, the electronic device may reproduce the received contents.

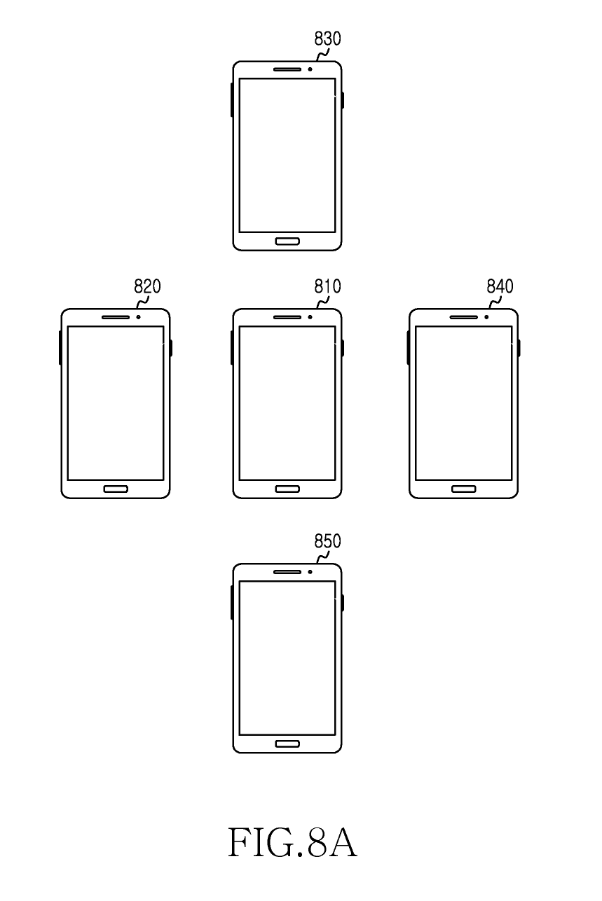

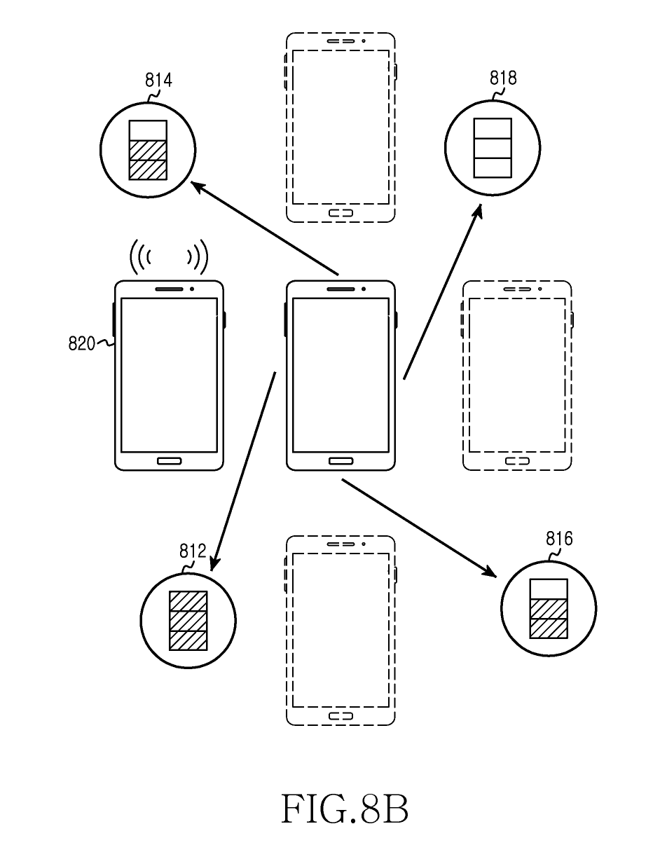

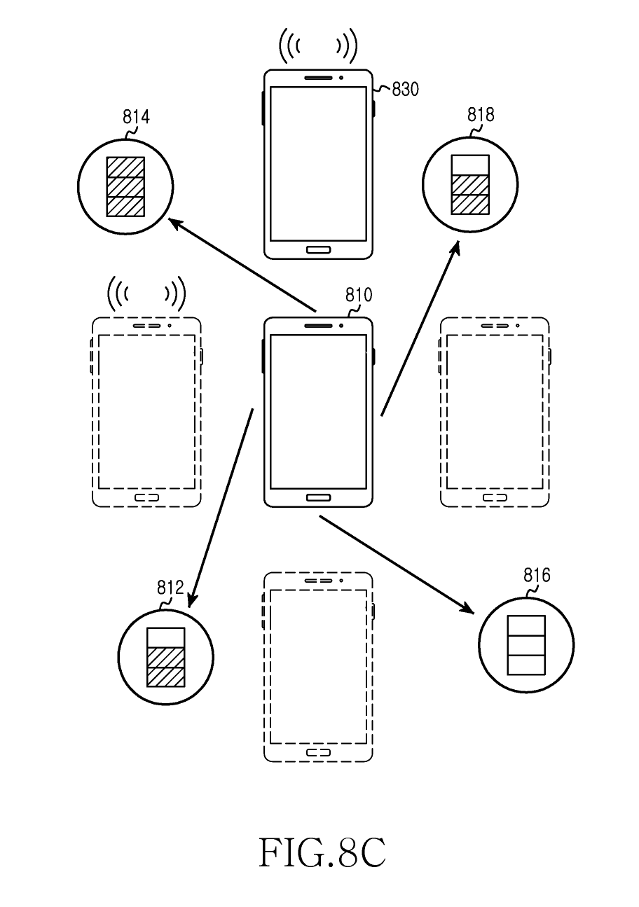

FIGS. 8A-8C are diagrams illustrating methods of an electronic device of determining a location of a peripheral electronic device in a sharing group, according to various embodiments of the present invention.

Referring to FIG. 8A, the electronic device 810 forms a group with at least one peripheral electronic device, thereby allowing for the sharing of contents. As shown in FIG. 8A, electronic device 810 forms a group with four peripheral electronic devices 820, 830, 840, and 850, with which it may share and reproduce content.

Electronic device 810 extracts a component of contents to reproduce and provides the extracted component to the peripheral electronic devices 820, 830, 840, and 850 based on a location of the peripheral electronic device to the electronic device 810.

According to an embodiment of the present invention, electronic device 810 determines a location (e.g., a direction and a distance) of the peripheral electronic devices 820, 830, 840, and 850 connected to a network (e.g., WiFi Direct). According to an embodiment, the electronic device 810 may detect a sound source reproduced in a peripheral electronic device included in the sharing group and determine the location of the peripheral electronic device. According to an embodiment of the present invention, the electronic device 810 may define a sound source reproduction order of the peripheral electronic devices 820, 830, 840, and 850 included in the sharing group and may request sound source reproduction and thus enable the peripheral electronic devices 820, 830, 840, and 850 to reproduce a sound source with a time difference.

As shown in FIG. 8B, the electronic device 810 requests to reproduce a sound source to a peripheral electronic device included in a sharing group and detects the sound source reproduced by the peripheral electronic device through a plurality of sensors disposed in different directions, thereby determining a generation direction and distance of the sound source. As shown in FIG. 8B, when requesting to reproduce a sound source to the peripheral electronic device 820 located at the left side based on the electronic device 810, the electronic device 810 may detect a sound source of a large sound through a sensor that detects a sound source of a left direction rather than a sensor that detects a sound source of upper, lower, and right directions. The electronic device 810 determines that a peripheral electronic device that reproduces a sound source is located at the left side using intensities 812, 814, 816, and 818 of the detected sound source.

By requesting reproduction of a sound source to another peripheral electronic device in which a location is not grasped, the electronic device 810 determines a sound source generation direction and a distance, as shown in FIG. 8C. As shown in FIG. 8C, when requesting to reproduce a sound source to the peripheral electronic device 830 located at the upper side of the electronic device 810, the electronic device 810 may detect a sound source of a large sound through a sensor that detects a sound source from an upper direction rather than a sensor that detects a sound source from lower, left, and right directions. The electronic device 810 determines that the peripheral electronic device 830 that reproduces a sound source using intensities 812, 814, 816, and 818 of the detected sound source is located at the upper side.

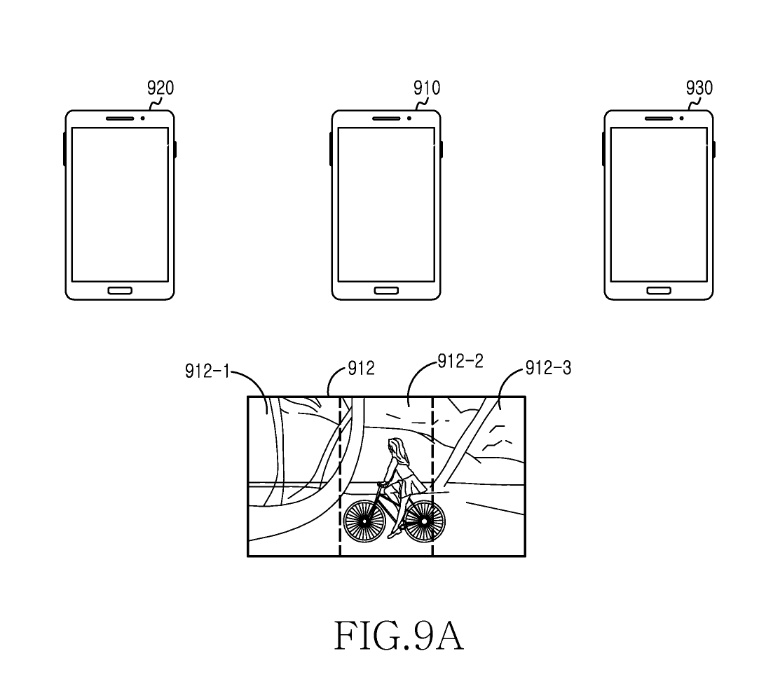

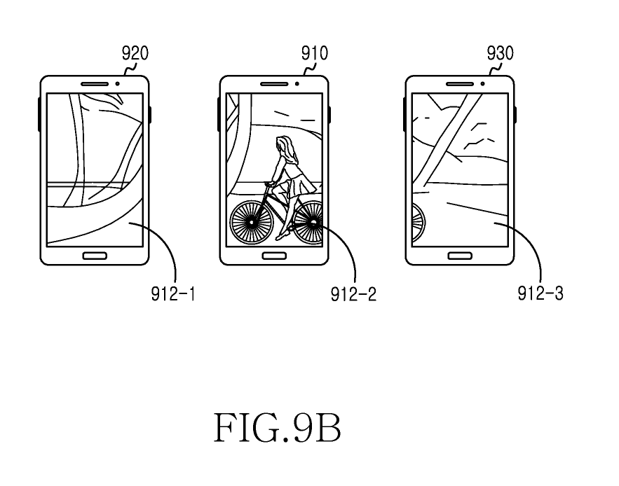

FIGS. 9A-9B are diagrams illustrating methods of reproducing contents in a peripheral electronic device, according to an embodiment of the present invention.

Referring to FIG. 9A, the electronic device 910 forms a sharing group with electronic devices 920 and 930.

Electronic device 910 extracts components of contents to reproduce and provides an extracted component to peripheral electronic devices 920 and 930, based on a location of each peripheral electronic device.

The electronic device 910 divides image data into a plurality of areas based on the location of the peripheral electronic devices 920 and 930. As shown in FIG. 9A, the electronic device 910 divides one image data 912 into a left image 912-1, a center image 912-2, and a right image 912-3.

As shown in FIG. 9B, by providing the left image 912-1 to the peripheral electronic device 920 located at the left side, by enabling the electronic device 910 located at a center position to reproduce an center image 912-1, and by providing the right image 912-3 to the peripheral electronic device 930 located at the right side, the electronic device 910 enables each electronic device to reproduce the divided image.

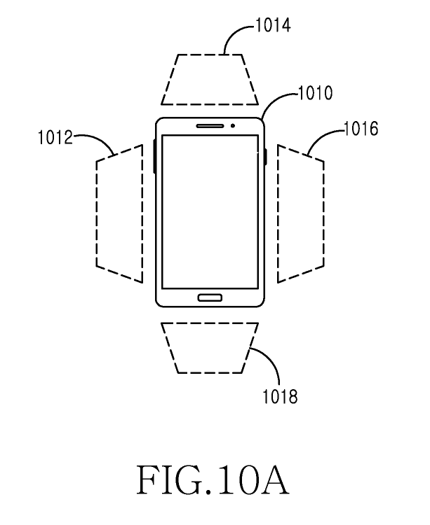

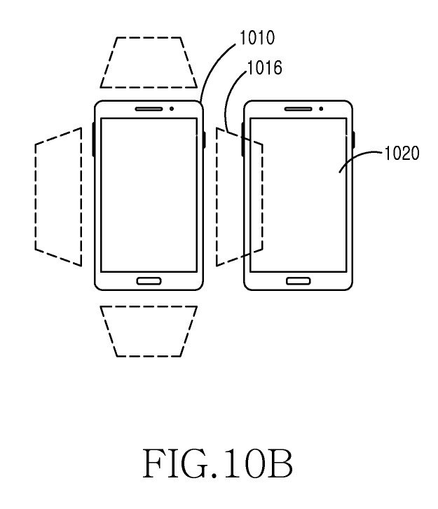

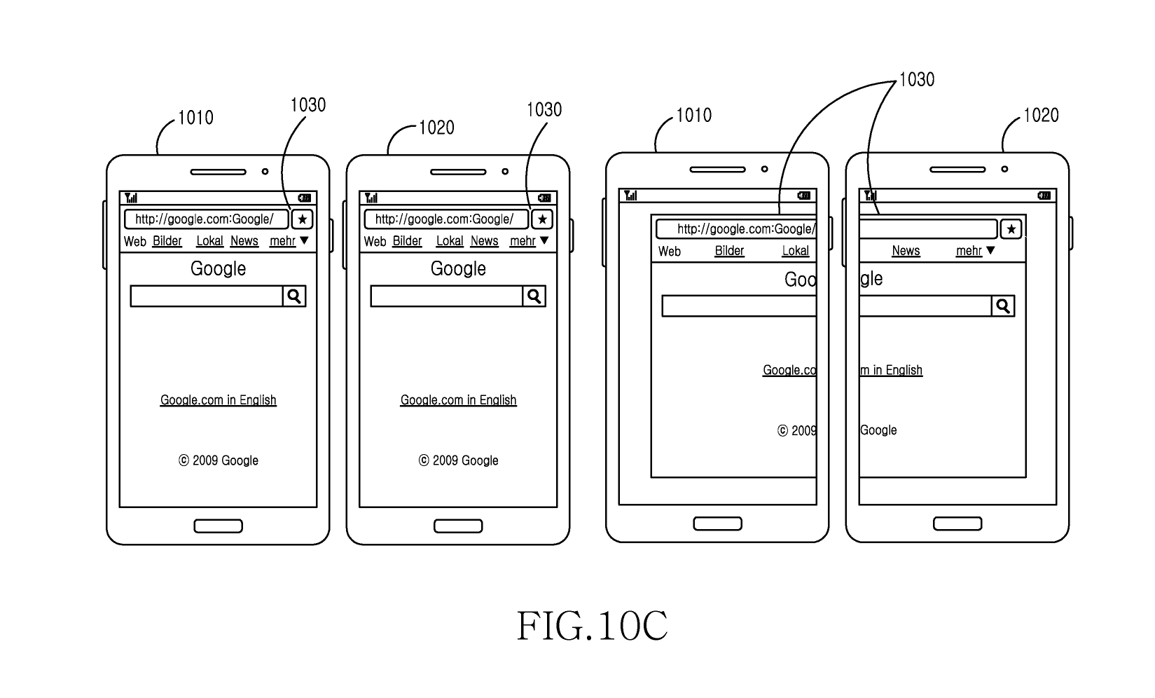

FIGS. 10A-10C are diagrams illustrating a method of an electronic device of determining a location of a peripheral electronic device in sharing group, according to another embodiment of the present invention.

Referring to FIGS. 10A to 10C, an electronic device 1010 may have at least one sensor that can detect an approach of a peripheral electronic device. The sensor detects an approach of a peripheral electronic device located in a predetermined range.

As shown in FIG. 10A, as the sensor is disposed at the right side, the left side, the upper side, and the lower side of the electronic device 1010, the sensor detects a peripheral electronic device that approaches in a direction of at least one of an upper predetermined range 1014, a lower predetermined range 1018, a left predetermined range 1012, and a right predetermined range 1016 of the electronic device 1010.

As shown in FIG. 10B, when the electronic device 1010 detects that a peripheral electronic device 1020 approaches in the right predetermined range 1016 sensing area, the electronic device 1010 performs a multi-screen function, as shown in FIG. 10C.

According to an embodiment of the present invention, the multi-screen function may include a function of enabling to output the same content 1030 on a screen of electronic device 1010, onto a screen of the peripheral electronic device 1020 adjacent to a screen 1030 of the electronic device 1010. Or the multi-screen function may include a function of using a screen of the peripheral electronic device 1020 adjacent to a screen of the electronic device 1010 as one screen 1030.

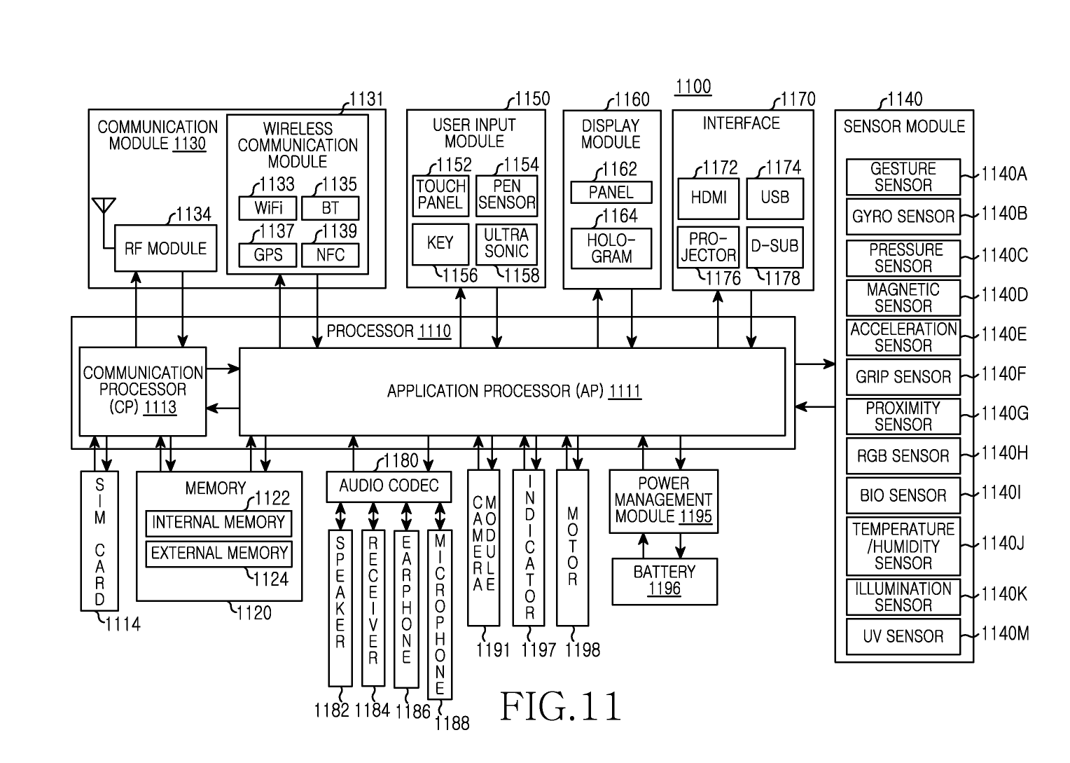

FIG. 11 is a block diagram illustrating a configuration of hardware 1100 according to various embodiments of the present invention.

The hardware 1100 may be, for example, the electronic device 100 of FIG. 1.

Referring to FIG. 11, the hardware 1100 includes at least one processor 1110, a Subscriber Identification Module (SIM) card 1114, a memory 1120, a communication module 1130, a sensor module 1140, a user input module 1150, a display module 1160, an interface 1170, an audio codec 1180, a camera module 1191, a power management module 1195, a battery 1196, an indicator 1197, or a motor 1198.

The processor 1110 may includes at least one Application Processor (AP) 1111 or at least one Communication Processor (CP) 1113. The processor 1110 may be, for example, the processor 120 of FIG. 1. FIG. 11 illustrates that the AP 1111 and the CP 1113 are included within the processor 1110, but the AP 1111 and the CP 1113 may be included within different Integrated Circuit (IC) packages, respectively. In an embodiment of the present invention, the AP 1111 and the CP 1113 may be included within an IC package.

The AP 1111 drives an operation system or an application program to control a plurality of hardware or software components connected to the AP 1111 and performs various data processing and operations including multimedia data. The AP 1111 may be implemented with, for example, a System on Chip (SoC). According to an embodiment of the present invention, the processor 1110 may further include a Graphic Processing Unit (GPU) (not shown).

The CP 1113 performs a function of managing a data link or converting a communication protocol in communication between other electronic devices connected to an electronic device (e.g., the electronic device 100) including the hardware 1100 by a network. The CP 1113 may be implemented with, for example, a SoC. According to an embodiment of the present invention, the CP 1113 may perform at least a portion of a multimedia control function. The CP 1113 may perform identification and authentication of a terminal within a communication network using, for example, a subscriber identification module (e.g., the SIM card 1114). Further, the CP 1113 may provide services such as audio dedicated communication, audiovisual communication, a text message, or packet data to the user.

Further, the CP 1113 controls data transmission and reception of the communication module 1130. In FIG. 11, elements of the CP 1113, the power management module 1195, or the memory 1120 are elements separate from the AP 1111, but according to an embodiment of the present invention, the AP 1111 may include at least a portion (e.g., the CP 1113) of the foregoing elements.

According to an embodiment of the present invention, the AP 1111 or the CP 1113 may load and process an instruction or data received from at least one of other elements or a non-volatile memory connected to each of the AP 1111 and the CP 1113 in a volatile memory. Further, the AP 1111 or the CP 1113 may store data received from at least one of other elements or generated by at least one of other elements at a non-volatile memory.

The SIM card 1114 is a card that implements a subscriber identity module and is inserted into a slot formed at a specific location of the electronic device. The SIM card 1114 includes intrinsic identification information (e.g., Integrated Circuit Card Identifier (ICCID)) or subscriber information (e.g., International Mobile Subscriber Identity (IMSI)).

The memory 1120 includes an internal memory 1122 or an external memory 1124. The memory 1120 may be, for example, the memory 140 of FIG. 1. The internal memory 1122 may include at least one of, for example, a volatile memory (e.g., Dynamic RAM (DRAM), Static RAM (SRAM), Synchronous Dynamic RAM (SDRAM)), or a non-volatile memory (e.g., One Time Programmable ROM (OTPROM), Programmable ROM (PROM), Erasable and Programmable ROM (EPROM), Electrically Erasable and Programmable ROM (EEPROM), mask ROM, flash ROM, NAND flash memory, and NOR flash memory). According to an embodiment of the present invention, the internal memory 1122 may have a form of a Solid State Drive (SSD). The external memory 1124 may further include a flash drive, for example, a Compact Flash (CF), Secure Digital (SD), Micro Secure Digital (Micro-SD), Mini Secure Digital (Mini-SD), extreme Digital (xD), or memory stick.

The communication module 1130 includes a wireless communication module 1131 or a Radio Frequency (RF) module 1134. The communication module 1130 may be, for example, the communication module 170 of FIG.1. The wireless communication module 1131 includes, for example, a WiFi module 1133, a Bluetooth (BT) module 1135, a GPS module 1137, or an NFC module 1139. For example, the wireless communication module 1131 may provide a wireless communication function using a radio frequency. Additionally or alternatively, the wireless communication module 1131 may include a modem or a network interface (e.g., a LAN card) that connects the hardware 1100 to a network (e.g., Internet, a LAN, a WAN, a telecommunication network, a cellular network, a satellite network, or a POTS).

The RF module 1134 performs transmission and reception of data, for example, transmission and reception of an RF signal or a called electronic signal. The RF module 1134 may include, for example, a transceiver, a Power Amp Module (PAM), a frequency filter, or a Low Noise Amplifier (LNA). Further, the RF module 1134 may further include a component, for example, a conductor or a conductive wire that transmits and receives electromagnetic waves on free space in wireless communication.

The sensor module 1140 may include at least one of, for example, a gesture sensor 1140A, a gyro sensor 1140B, an atmospheric pressure sensor 1140C, a magnetic sensor 1140D, an acceleration sensor 1140E, a grip sensor 1140F, a proximity sensor 1140G, a Red, Green, and Blue (RGB) sensor 1140H, a bio sensor 1140I, a temperature/humidity sensor 1140J, an illumination sensor 1140K, or a Ultra Violet (UV) sensor 1140M. The sensor module 1140 measures a physical quantity or detects an operation state of en electronic device and converts the measured or detected information into an electrical signal. Additionally or alternatively, the sensor module 1140 may include, for example, an E-nose sensor, an electromyography sensor (EMG sensor), an electroencephalogram sensor (EEG sensor), an electrocardiogram sensor (ECG sensor), or a fingerprint sensor. The sensor module 1140 may further include a control circuit that controls at least one sensor belonging to the inside thereof.

The user input module 1150 includes a touch panel 1152, a (digital) pen sensor 1154, a key 1156, or an ultrasonic wave input device 1158. The user input module 1150 may be, for example, the user input module 150 of FIG.1. The touch panel 1152 recognizes a touch input with at least one method of, for example, a capacitive, resistive, infrared ray, or ultrasonic wave method. Further, the touch panel 1152 may further include a controller (not shown). A capacitive touch panel can perform proximity recognition as well as a direct touch. The touch panel 1152 may further include a tactile layer. In this case, the touch panel 1152 may provide a haptic reaction to the user.

The (digital) pen sensor 1154 is implemented using the same method as and a method similar to, for example, reception of a touch input of the user or a separate recognition sheet. As the key 1156, for example, a keypad or a touch key may be used. The ultrasonic wave input device 1158 determines data by detecting a sound wave with a microphone (e.g., a microphone 1188) in a terminal through a pen that generates an ultrasonic wave signal and may perform wireless recognition. According to an embodiment of the present invention, the hardware 1100 may receive a user input from an external device (e.g., a network, computer, or server) connected to the communication module 1130 using the communication module 1130.

The display module 1160 includes a panel 1162 or a hologram 1164. The display module 1160 may be, for example, the display module 160 of FIG.1. The panel 1162 may be, for example, a Liquid Crystal Display (LCD) or an Active-Matrix Organic Light-Emitting Diode (AMOLED). The panel 1162 may be implemented with, for example, a flexible, transparent, or wearable method. The panel 1162 and the touch panel 1152 may be formed in a module. The hologram 1164 may show a stereoscopic image in the air using interference of light. According to an embodiment of the present invention, the display module 1160 may further include a control circuit for controlling the panel 1162 or the hologram 1164.

The interface 1170 may include, for example, a High-Definition Multimedia Interface (HDMI) 1172, a Universal Serial Bus (USB) 1174, a projector 1176, or a D-subminiature (D-sub) 1178. Additionally or alternatively, the interface 1170 may include, for example, Secure Digital (SD)/Multi-Media Card (MMC)(not shown), or Infrared Data Association (IrDA) (not shown).

The audio codec 1180 interactively converts an audio and an electric signal. For example, the audio codec 1180 converts audio information input or output through a speaker 1182, a receiver 1184, an earphone 1186, or a microphone 1188.

The camera module 1191 photographs an image and a moving picture, and according to an embodiment of the present invention, the camera module 1191 may include at least one image sensor (e.g., a front surface lens or a rear surface lens), an Image Signal Processor (ISP), or a flash LED.

The power management module 1195 manages the power of the hardware 1100. The power management module 1195 may include, for example, a Power Management Integrated Circuit (PMIC), a charger Integrated Circuit (charge IC), or a battery fuel gauge.

The PMIC may be mounted within, for example, an IC or a SoC semiconductor. A charging method is classified into a wired method and a wireless method. The charge IC charges a battery and prevents an overvoltage or an overcurrent from being injected from a charger. According to an embodiment of the present invention, the charge IC includes a charge IC for at least one of a wired charge method and a wireless charge method. The wireless charge method may include, for example, a magnetic resonance method, a magnetic induction method, or an electromagnetic wave method and may add an additional circuit for wireless charge, for example, a circuit such as a coil loop, a resonant circuit, and a rectifier.

The battery gauge measures, for example, a residual quantity of the battery 1196, a voltage, a current, or a temperature while charging. The battery 1196 generates electricity and supply power and may be, for example, a rechargeable battery.

The indicator 1197 displays a specific state, for example, a booting state, a message state, or a charge state of the hardware 1100 or a portion (e.g., the AP 1111) thereof. The motor 1198 converts an electrical signal to a mechanical vibration. The Main Control Unit (MCU) controls the sensor module 1140.

Although not shown, the hardware 1100 may include a processing device (e.g., Graphics Processing Unit (GPU)) for supporting a mobile television. The processing device for supporting a mobile television may process media data according to a specification of, for example, Digital Multimedia Broadcasting (DMB), Digital Video Broadcasting (DVB), or media flow.

According to various exemplary embodiments, there is provided a computer readable record medium on which an application or a program for performing the method of determining at least one of a direction and a distance of a peripheral electronic device and of defining contents to share based on the direction or the distance of the peripheral electronic device is recorded in an electronic device.

The various embodiments describing the present invention may be performed through at least one program included in the memory 140 of the electronic device 100 and may be directly controlled by the processor 120. Further, various embodiments may be controlled through at least one control module which the processor 120 controls.

Methods, according to various embodiments described in claims and/or the specification of the present invention, may be implemented in a form of hardware, software, or a combination of hardware and software. When implemented with software, a computer readable storage medium that stores at least one program (software module) may be provided. At least one program stored at the computer readable storage medium may be executed by at least one processor within the electronic device 100. At least one program may include an instruction that enables the electronic device 100 to execute methods according to various embodiments described in claims and/or specification of the present invention.

Such a program (software module software) may be stored at a non-volatile memory including a Random Access Memory (RAM) and a flash memory, a Read-Only Memory (ROM), an Electrically Erasable and Programmable ROM (EEPROM), a magnetic disk storage device, a Compact Disk ROM (CD-ROM), a Digital Versatile Disk (DVD), or an optical storage device of other form, and a magnetic cassette. Alternatively, the program may be stored at a memory formed with a combination of a portion or the entire thereof. Further, each constituent memory may be included in plural.

The program may be stored at an attachable storage device that may approach the electronic device 100 through a communication network such as Internet, Intranet, a LAN, a Wireless LAN (WLAN), or a Storage Area Network (SAN) or a communication network formed with a combination thereof. Such a storage device may connect to the electronic device 100 through an external port.

Further, a separate storage device on the communication network may connect to a portable electronic device 100.

An electronic device according to various embodiments of the present invention reproduces contents based on a location of a peripheral electronic device connected by a network.

While the present invention has been particularly shown and described with reference to embodiments thereof, it will be understood by those skilled in the art that various changes in form and details is made therein without departing from the spirit and scope of the present invention as defined by the appended claims.

What is claimed is:

1. An electronic device, comprising:
a communication unit configured to connect a network to a second electronic device;
an information collection module configured to collect information necessary for determining a location of the second electronic device; and
at least one processor configured to determine the location of the second electronic device based on the information collected by the information collection module, define contents to reproduce in the second electronic device based on the location, and provide the contents to the second electronic device.

2. The electronic device of claim 1, wherein the information collection module comprises at least one of an image sensor, a microphone, a grip sensor, an optical sensor, and an approach sensor.

3. The electronic device of claim 1, wherein the processor is further configured to determine location information corresponding to at least one of a direction and a distance of the second electronic device.

4. The electronic device of claim 1, wherein the contents comprise applications formed with at least one of a picture, music, video, an e-book, a web page, and a multi-screen.

5. The electronic device of claim 1, wherein the processor is further configured to determine a sound source reproduced by the second electronic device to determine the location of the second electronic device.

6. The electronic device of claim 1, wherein the processor is further configured to detect an approach of the second electronic device to determine the location of the second electronic device.

7. The electronic device of claim 1, wherein the processor is further configured to define the contents to provide to at least one additional electronic device connected to the electronic device.

8. A method of reproducing contents of an electronic device, the method comprising:
forming a group with at least one second electronic device, using a network;
determining a location of the at least one second electronic device;
defining a main component and a sub-component of reproduction contents, based on the location of the at least one second electronic device; and
transmitting the main component and the sub-component to the at least one second electronic device.

9. The method of claim 8, wherein determining the location comprises determining an approach of the at least one second electronic device using at least one sensor.

10. The method of claim 8, wherein determining the location comprises detecting a sound output by the at least one second electronic device using at least one sensor.

11. The method of claim 10, wherein determining the location further comprises at least one of providing a test sound source to the at least one second electronic device or requesting to reproduce audio data stored at the at least one second electronic device.

12. The method of claim 10, wherein determining the location further comprises controlling the at least one second electronic device to sequentially output a sound.

13. The method of claim 8, wherein determining the location comprises:
acquiring an image of the at least one second electronic device using at least one sensor; and
determining the location of the at least one second electronic device by analyzing the acquired image.

14. The method of claim 8, wherein the main component is an area of the contents to be reproduced in the electronic device, and
the sub-component is an area of the contents to be reproduced in the at least one second electronic device.

15. The method of claim 8, wherein defining the main component comprises:
extracting a sub-component from the reproduction contents; and
transmitting the extracted sub-component to the at least one second electronic device.

16. The method of claim 8, wherein defining the main component comprises:
defining a sub-component from the reproduction contents; and
transmitting the reproduction contents and information related to the defined sub-component to the at least one second electronic device,
wherein the at least one second electronic device extracts a sub-component from the reproduction contents, based on the information related to the defined sub-component.

17. The method of claim 8, wherein the sub-component comprises any one of a channel component of audio data, a divided screen of image data, and a divided screen of an application.

18. The method of claim 8, further comprising determining an operation mode of the electronic device, when the group is formed with the at least one second electronic device,
wherein the operation mode comprises one of a master mode which provides contents and a slave mode which reproduces the provided contents.

19. A non-transitory computer readable recording medium on which an application or a program for performing determining at least one of a direction and a distance of a second electronic device, and defining contents to share, based on the direction or the distance of the second electronic device, is recorded in an electronic device.
